(19) United States
(12) Patent Application Publication
(10) Pub. No.: US 2026/0041081 A1
(43) Pub. Date: Feb. 12, 2026

(54) SKEETER WEEPER® SMART PEST CONTROL MISTING SYSTEM

(71) Applicant: Hoda Ballout, Dallas, TX (US)

(72) Inventor: Hoda Ballout, Dallas, TX (US)

(21) Appl. No.: 19/291,564

(22) Filed: Aug. 5, 2025

Related U.S. Application Data
(60) Provisional application No. 63/680,211, filed on Aug. 7, 2024.

(51) Int. Cl. A01M 1/20

(52) U.S. Cl. CPC A01M 1/2038

(57) ABSTRACT

An automated outdoor pest control misting system is disclosed, comprising one or more weather-resistant, permanently installed misting stations configured to disperse a natural, minimum-risk misting pesticide over a designated treatment area. Each misting station includes a reservoir for storing the pest control solution, a pressurizing mechanism for delivering the solution to at least one atomizing nozzle and a control module operatively connected to the pressurized mechanism. The control module is configured for programmable and remote operation via a wireless communication interface enabling scheduled or on-demand misting without manual intervention. The system is operable to apply pest control treatments at predetermined intervals, thereby reducing the time, labor and cost associated with traditional manual or hose-based systems, while promoting environmental sustainability and user safety.

### FIELD OF THE INVENTION

The present invention relates generally to pest control systems and more particularly, to automated outdoor misting systems for the application of natural pest repellents and treatments. Specifically, the invention concerns weather-resistant, permanently installed, remotely controlled misting stations designed to automate and optimize outdoor natural pest control, reducing the time, labor and monetary cost associated with traditional pest management methods while improving environmental sustainability and user safety.

### BACKGROUND OF THE INVENTION

Outdoor pest control is essential for maintaining comfortable, safe and usable outdoor spaces; however, existing solutions present significant limitations in terms of efficiency, convenience, cost and environmental impact. Traditional pest management methods often require manual application of sprays, ULV fogger/misting of various pesticides-which is time-consuming, physically demanding and exposes users to potential health risks from direct contact with pesticides. Automated systems currently available on the market frequently rely on extensive tube-or hose-based networks that are complex to install, difficult to maintain and considerably more expensive for the consumer.

In addition, many conventional systems utilize synthetic chemical pesticides that may be harmful to humans, pets, beneficial insects such as pollinators and the surrounding environment. The use of such chemicals can result in negative ecological effects, reduced biodiversity and regulatory restrictions. Consumers seeking natural pest control options often face trade-offs between environmental safety, effective performance, and efficient treatment durations-as many natural solutions require frequent manual applications to maintain efficacy.

Accordingly, there exists a need for an outdoor pest control system that is cost-effective, easy to install and capable of automating the application of natural pest repellents without requiring extensive manual labor or complex infrastructure. Such a system should be weather-resistant, capable of providing consistent coverage and designed to minimize health risks and environmental harm while maximizing convenience and effectiveness. The present invention addresses these needs.

### SUMMARY OF THE INVENTION

The present invention provides an automated, weather-resistant, outdoor natural pest control misting system that reduces the time, physical effort and cost traditionally required for outdoor pest management while promoting environmental sustainability and user safety. The system consists of permanent misting stations configured for automated and remotely controlled operation to disperse natural pest repellents and treatments over designated outdoor areas. Unlike traditional pest control methods that rely on manual spraying or complex and costly tube-or hose-based systems this invention minimizes physical labor, simplifies installation and offers a significantly more cost-effective solution for consumers. By automating the application of natural pest control treatments on a scheduled or on-demand basis, the system provides consistent and effective pest management enabling users to enjoy pest-controlled outdoor spaces without the inconvenience, health risks or environmental impact associated with conventional pesticide application methods.

### DESCRIPTION OF THE DRAWING

FIG. 1 illustrates a perspective view of the compact system (100) combining a ULV fogger/mister, weather-resistant housing and Wi-Fi control node for remote-operated, durable and efficient outdoor misting (115). Each unit possesses a 50-foot weather safe power cable (102) which extends from the ULV fogger/misting unit enabling flexible placement and connection to power or control modules. The system features an app connection button (104) for establishing wireless communication with a user's mobile device, facilitating remote operation. The system's specialized weather-resistant housing (105) is integrated into the unit to hold the fogging/misting mechanism and natural pest control solution, which is dispersed during misting events (treatment sessions). The system's enclosed weather-resistant housing enables safe and continuous outdoor operation (115) by protecting associated components from environmental elements. While the WiFi control box manages the ULV fogger/misting unit operations and allows for connectivity with a mobile app for scheduling, monitoring and real-time activation. This figure represents the main physical hardware of the system designed for automated and convenient outdoor pest control.

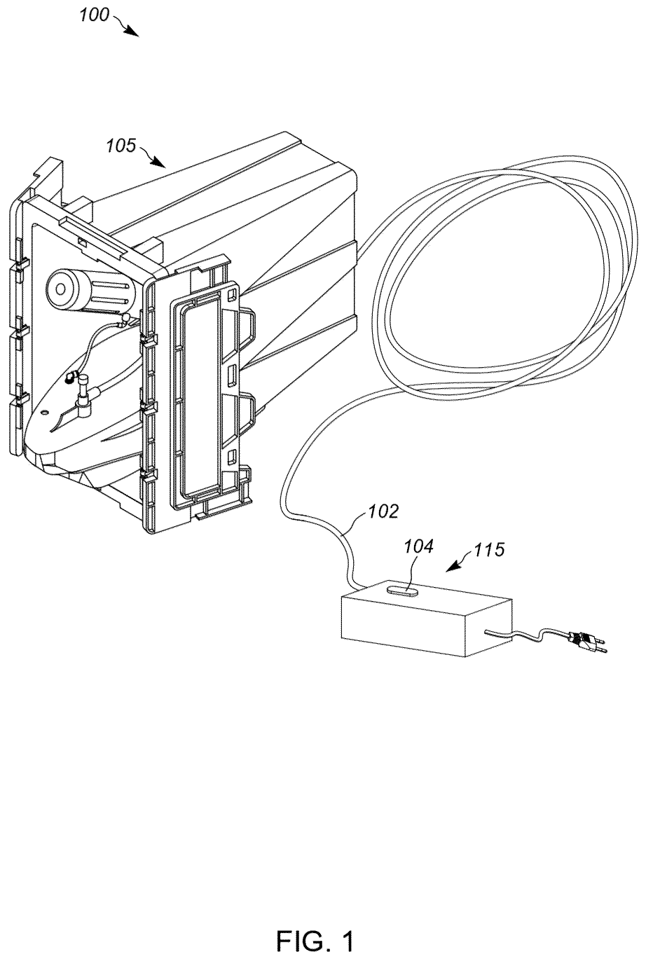

FIG. 2 presents an isometric overview of the system (200) in use showing a user or operator (202) controlling the pest control process through a user device (204) such as a smartphone or tablet. The user device communicates with the system via a cloud network (210) enabling remote operation and monitoring. The perspective view of the compact system combining a ULV fogger/mister, specialized weather-resistant housing and Wi-Fi control unit for remote-operated, durable and efficient outdoor misting (100) is depicted in operation, dispersing fog or mist (206) radiating outward from its misting heads to cover the target area. This configuration illustrates how the system allows the operator to manage pest control treatments from any location with network access ensuring efficient and consistent application.

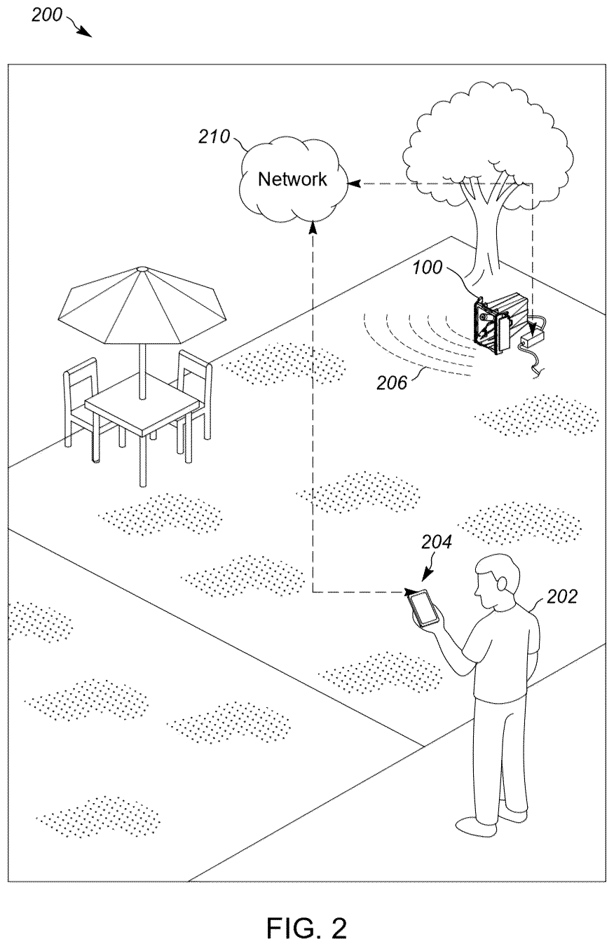

FIG. 3 illustrates a modular block diagram (300) of the system architecture, demonstrating the communication flow between the user device (204), the cloud controller (302), and the ULV fogger/misting unit (304). The user device serves as the interface through which user input is provided such as initiating misting operations or checking system status. This input is transmitted to the cloud controller (302) which acts as the central processing unit of the system. The cloud controller interprets the input, verifies operational parameters, and generates a trigger command to activate the ULV fogger/misting unit (304). Once the ULV fogger/misting unit executes the misting event, it sends a status feedback signal back through the cloud controller to the user device confirming the completion of the operation or providing real-time updates. This diagram demonstrates the intelligent, connected structure of the system enabling automated and remote control of pest misting operations.

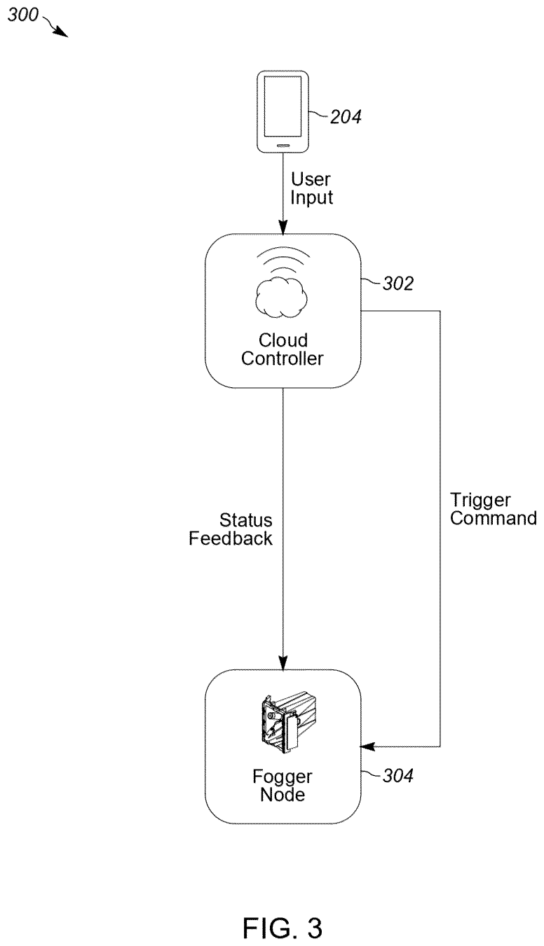

FIG. 4 depicts a connectivity and deployment map of the system (400) illustrating the spatial arrangement and communication links between its components. The perspective view of the compact system combining a ULV fogger/misting unit, weather-resistant housing and Wi-Fi control unit (100) for remote-operated, durable and efficient outdoor misting with a defined coverage zone (402) representing the approximately effective treatment area reached by the emitted mist. The ULV fogger/misting unit communicates wirelessly with a cloud network (210) which serves as the central processing and coordination hub. A user device (204) such as a smartphone or tablet, interfaces with the cloud network to allow remote control, scheduling and monitoring of the pest control operations. This figure illustrates how the system integrates spatial deployment, sensor feedback and cloud-based connectivity to optimize misting performance and coverage.

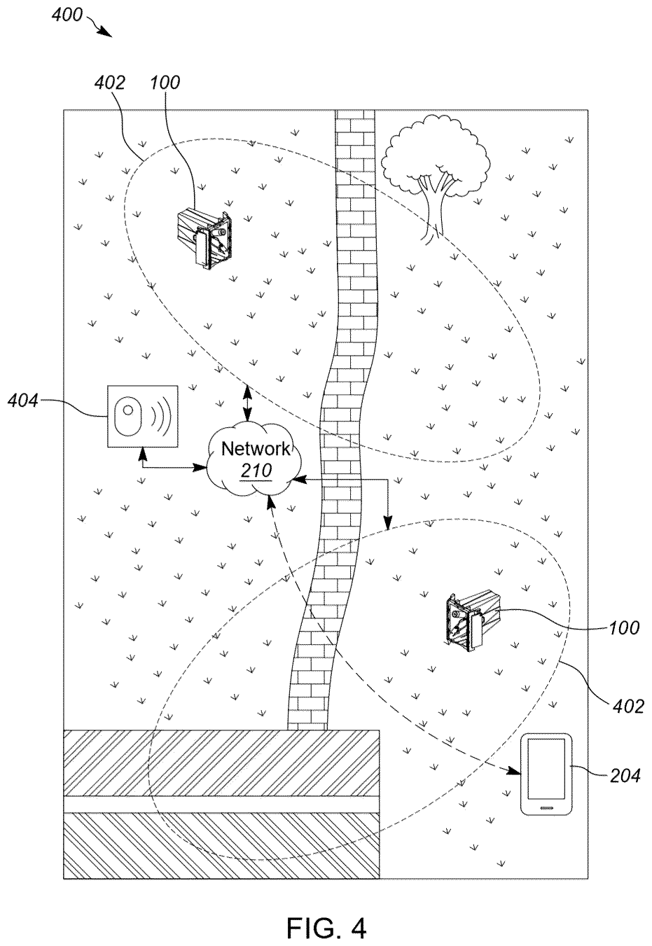

FIG. 5 shows an app interface mockup (500) illustrating the mobile app interface (502) used to control and monitor the pest control misting system. The interface displays a misting status indicator showing the system as “ACTIVE” along with a scheduling section indicating the last misting event occurred five minutes ago. A manual trigger option is provided for on-demand activation of the system. The app communicates with the perspective view of the compact system combining a ULV fogger/mister, weather-resistant housing and Wi-Fi control unit for remote-operated, durable and efficient outdoor misting (100) through the cloud network (210) enabling the user to remotely initiate, schedule and monitor pest control treatments in real time. This figure demonstrates the user-friendly, connected nature of the control system allowing for precise operational management from a mobile device.

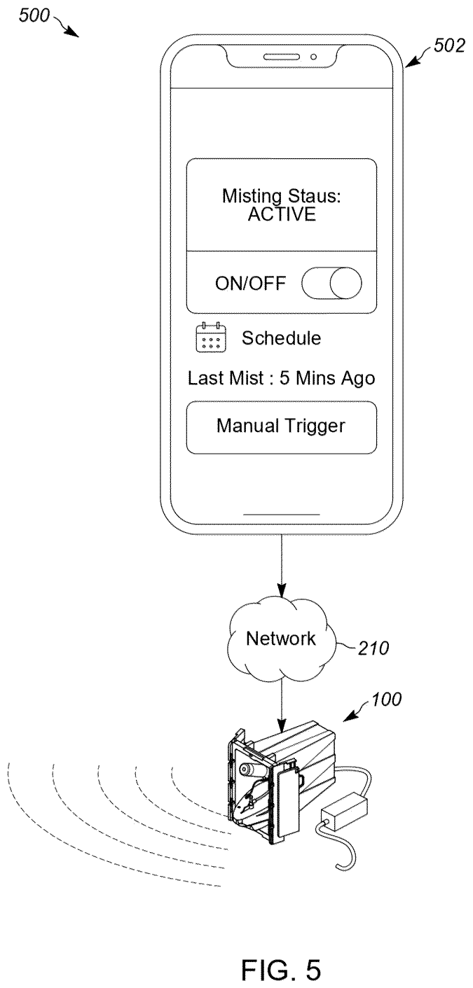

FIG. 6 illustrates an automation flowchart (600) outlining the operational logic of the pest control misting system. At the core of the process is the automation brain (602), which receives input from multiple control sources. A schedule trigger (604) initiates misting events automatically based on preprogrammed timing parameters, while a manual override (608) allows the user to bypass automated scheduling when immediate activation is desired. An app command (606), transmitted from the user's mobile application can also initiate system operation remotely. Upon receiving any of these inputs, the automation brain processes the command and, if operational conditions are met, generates an auto trigger spray signal that activates the misting mechanism. This results in a mist event (610) during which the natural pest control solution is dispersed over the treatment area. The flowchart illustrates how the system integrates scheduled automation, remote user input and manual control to deliver flexible and efficient pest management.

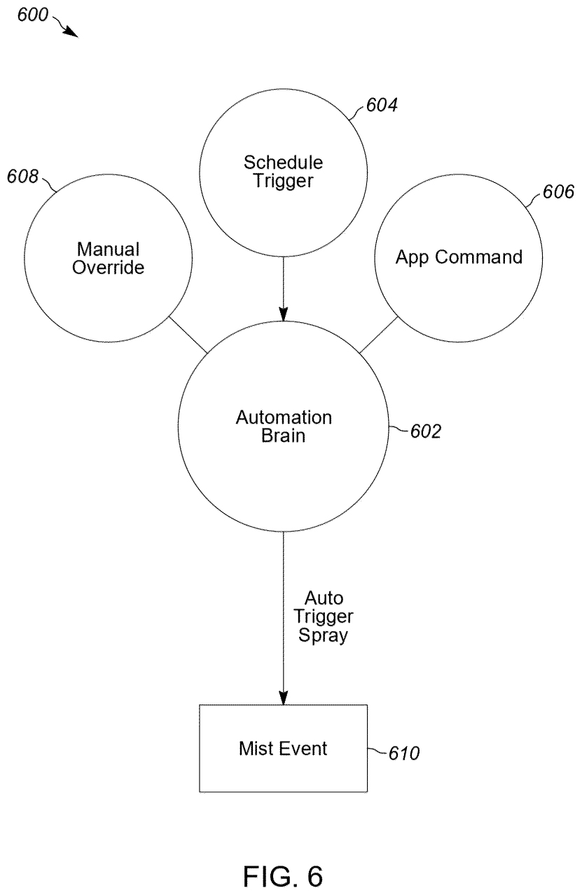

### DESCRIPTION OF THE INVENTION

The present invention is an automated outdoor natural pest control misting system designed to provide consistent, effective and environmentally safe pest management with minimal user effort. The system comprises one or more weather-resistant misting stations that are permanently installed in outdoor areas requiring pest control coverage. Each station contains an integrated reservoir for storing a pest control solution which may be formulated from natural, non-toxic ingredients such as essential oils, plant extracts or other environmentally safe compounds that are effective in repelling or eliminating pests while being safe for humans, pets and beneficial insects when used as directed. In the United States these would comprise EPA FIFRA 25(b) minimum-risk misting pesticides. The misting station further includes a pumping or pressurizing mechanism to draw the solution from the reservoir and deliver it to one or more atomizing nozzles. These nozzles produce a fine mist that is dispersed evenly into the surrounding air and onto vegetation and surfaces, creating a protective barrier that deters and controls populations of mosquitoes, flies, gnats, ticks and many other nuisance insects.

The stations are constructed from durable, weather-resistant materials that protect internal components from environmental factors such as rain, UV radiation, humidity and temperature fluctuations thereby ensuring long-term outdoor operation. The housing may be made from treated metal, reinforced plastics or composite materials and internal seals and gaskets may be employed to prevent water ingress and corrosion. The system is designed for both standalone operation and networked integration with multiple stations to allow for expanded coverage across larger properties. When deployed in a network configuration, the stations may communicate wirelessly to synchronize operation schedules ensuring optimal coverage and reducing redundancy.

The control system integrated into each station may include programmable timers, wireless communication modules and user interfaces that allow remote control via smartphone applications, web platforms or other wireless devices.

Users may program the system to operate on a fixed schedule, activating at specific times of day when pests are most active, or may trigger misting manually on demand. Adjustable parameters such as spray duration, interval timing and mist intensity and angle of spray may be set through the app or manual control enabling customization of treatment based on environmental conditions, pest population levels and user preferences. The control module may also include sensors to detect environmental conditions such as wind speed, temperature, humidity or rainfall allowing the system to optimize operation for efficiency and avoid unnecessary spraying during adverse weather conditions.

Power for the misting stations may be supplied by various means including standard AC electrical connections, rechargeable battery systems or solar power modules for locations without easy access to electrical outlets. The design of the system allows for simple and quick installation without the need for extensive tubing networks or permanent connection to irrigation systems thereby reducing the time, labor and cost associated with setup. Maintenance requirements are minimal, consisting primarily of periodic refilling of the solution reservoir and basic cleaning of nozzles to prevent clogging.

In operation, the system delivers a consistent level of pest control by applying natural treatments at regular intervals or in response to user commands, reducing the reliance on manual spraying methods that are labor-intensive and inconsistent in coverage. By automating the process, the invention ensures that pest control is applied at optimal times and in appropriate quantities, improving treatment efficacy while minimizing waste and environmental impact. The system thus addresses the shortcomings of traditional pest management methods which are either overly dependent on manual application or require costly, complex installation of hose and tube-based misting networks. This invention provides a cost-effective, efficient and user-friendly solution that makes natural pest control more accessible to a wide range of users, from residential homeowners to commercial property managers while contributing to environmental sustainability and reducing potential health risks associated with conventional pesticide usage.

1. An automated outdoor pest control misting system, comprising:
a weather-resistant housing configured for permanent outdoor installation;
a reservoir disposed within the housing for storing a pest control solution comprising natural, non-toxic ingredients;
a pumping/pressurizing mechanism configured to deliver the pest control solution from the reservoir to at least one atomizing nozzle;
the at least one atomizing nozzle configured to disperse the pest control solution into a mist over a treatment area;
a control module operatively connected to the pumping mechanism, the control module configured to selectively activate the pumping mechanism according to one or more user-defined schedules or remote commands; and
a wireless communication interface configured to receive operational commands from a remote device,
wherein the system is operable to automatically apply pest control treatments at predetermined intervals without manual intervention.

2. The system of claim 1, wherein the pest control solution comprises EPA FIFRA 25(b) minimum-risk misting pesticides.

3. The system of claim 1, wherein the housing is constructed from weather-resistant materials comprising UV-stabilized polymers, corrosion-resistant metals or composite materials.

4. The system of claim 1, wherein the control module is configured to adjust misting duration, misting frequency and misting intensity according to user input.

5. The system of claim 1, wherein the wireless communication interface is configured to communicate via Wi-Fi, Bluetooth or cellular network protocols with a remote computing device.

6. The system of claim 1, wherein the pumping mechanism is powered by an energy source selected from the group consisting of mains electricity, a rechargeable battery and a solar power module.

7. The system of claim 1, wherein a plurality of misting stations is configured to operate in a coordinated manner to provide expanded coverage of an outdoor area.

8. The system of claim 1, wherein the plurality of misting stations communicates wirelessly to synchronize operational schedules.

9. The system of claim 1, wherein the misting station is configured for installation without the use of an extensive hose or tubing network.
